(19) United States
(12) Patent Application Publication
(10) Pub. No.: US 2009/0036197 A1
(43) Pub. Date: Feb. 5, 2009

(54) GAMING MACHINE HAVING ELECTROPHORETIC DISPLAYS AND METHOD THEREOF

(75) Inventors: Peter R. Anderson, Glenview, IL (US); Charles R. Bleich, Cary, IL (US); Timothy C. Loose, Chicago, IL (US); James M. Rasmussen, Chicago, IL (US); Gene Rigsby, Chicago, IL (US); Richard T. Schwartz, Chicago, IL (US)

Correspondence Address: SCHWEGMAN, LUNDBERG & WOESSNER/WMS GAMING, P.O. BOX 2938, MINNEAPOLIS, MN, 55402, US

(73) Assignee: WMS Gaming Inc., Waukegan, IL (US)

(21) Appl. No.: 12/243,607

(22) Filed: Oct. 1, 2008

Related U.S. Application Data
(62) Division of application No. 11/275,155, filed on Dec. 15, 2005.
Application No. 11/275,155 is a continuation-in-part of application No. PCT/US05/29919, filed on Aug. 24, 2005.
(60) Provisional application No. 60/606,381, filed on Sep. 1, 2004.

(51) Int. Cl. A63F 13/00; A63F 9/24

(52) U.S. Cl. 463/20; 463/25

(57) ABSTRACT

A gaming machine for conducting a wagering game includes a value input device for receiving a wager and at least one rotatable reel. The reel comprises a reel strip arranged about the periphery of a cage. The reel strip, buttons on the machine, a player tracking card, and/or a gaming machine credit ticket may each comprise alterable film for displaying a plurality of indicia, including images, text, and other information. The gaming machine further comprises a controller operative to alter the appearance of items displayed on the film.

### RELATED APPLICATIONS

This application is a Divisional of U.S. patent application Ser. No. 11/275,155, filed on Dec. 15, 2005, which claims priority as a Continuation-in-Part under 35 U.S.C. 111(a) of International Application No. PCT/US2005/029919, filed Aug. 24, 2005, which in turn claims priority to U.S. Provisional Application Ser. No. 60/606,381, filed Sep. 1, 2004, the contents of which are each incorporated herein by reference in their entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### TECHNICAL FIELD

The various embodiments described herein generally relate to gaming machines and their operations, including wagering game play.

### BACKGROUND

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

One concept that has been successfully employed to enhance the entertainment value of a game is the concept of a “secondary” or “bonus” game that may be played in conjunction with a “basic” game. The bonus game may comprise any type of game, either similar to or completely different from the basic game, which is entered upon the occurrence of a selected event or outcome in the basic game. Generally, bonus games provide a greater expectation of winning than the basic game and may also be accompanied with more attractive or unusual video displays and/or audio. Bonus games may additionally award players with “progressive jackpot” awards that are funded, at least in part, by a percentage of coin-in from the gaming machine or a plurality of participating gaming machines. Because the bonus game concept offers tremendous advantages in player appeal and excitement relative to other known games, and because such games are attractive to both players and operators, there is a continuing need to develop gaming machines with new types of bonus games to satisfy the demands of players and operators.

Traditional gaming machines have incorporated a variety of displays to improve gameplay depiction, as well as provide signage on the gaming machine. However, displays in traditional mechanical reel gaming machines are limited given the static nature of the reel strips on each reel. One limitation with traditional mechanical reel slot machines is that in order for the gaming machine to be updated with a new or different game, the physical reel strips on the reels must be manually changed. Moreover, traditional displays such as LCD video displays and LEDS consume considerable quantities of power, particularly as gaming machine manufacturers strive to add more displays to increase the aesthetics and attraction of their products. Traditional displays also lack versatility due to their rigidity, viewing angle, and lower contrast.

### BRIEF DESCRIPTION OF THE DRAWINGS

FIG. 1 is a perspective view of a gaming machine embodying the present invention;

FIG. 2 is a block diagram of a control system suitable for operating the gaming machine;

FIG. 3 is a perspective view of a mechanical reel of the gaming machine of FIG. 1;

FIG. 4 is a cross-sectional view of an electrophoretic display; and

FIGS. 5a-5d are perspective views of alternative embodiments of the mechanical reel of the present invention.

### DETAILED DESCRIPTION

While embodiments of this invention may be realized in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

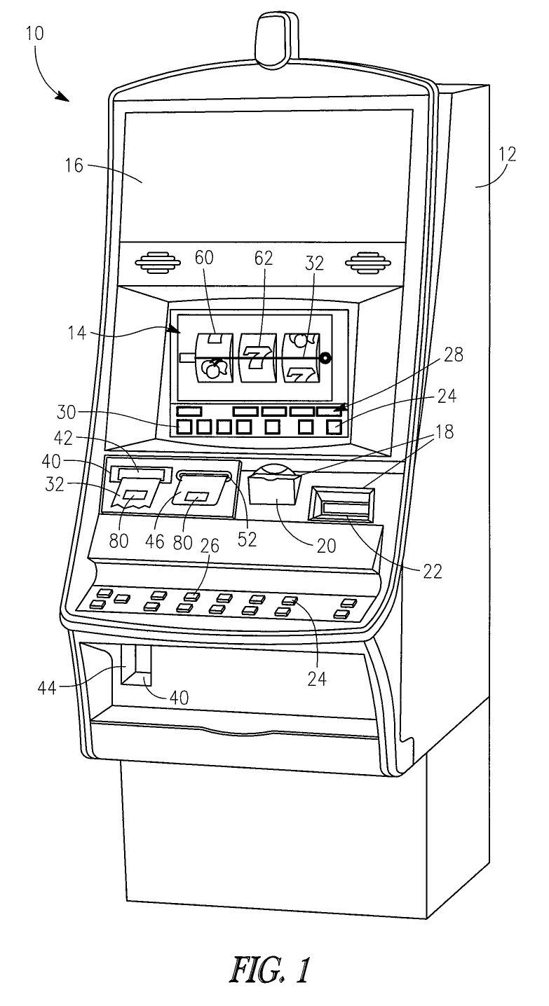

Referring to FIG. 1, a gaming machine 10 is used in gaming establishments such as casinos. With regard to the present invention, the gaming machine 10 may be any type of gaming machine and may have varying structures and methods of operation. For example, the gaming machine 10 may be an electromechanical gaming machine configured to play mechanical slots, or it may be an electronic gaming machine configured to play a video casino game, such as blackjack, slots, keno, poker, blackjack, roulette, etc.

The gaming machine 10 comprises a housing 12 and includes input devices, including a value input device 18 and a player input device 24. For output the gaming machine 10 includes a primary display 14 for displaying information about the basic wagering game. The primary display 14 can also display information about a bonus wagering game and a progressive wagering game. The gaming machine 10 may also include a secondary display 16 for displaying game events, game outcomes, and/or signage information. While these typical components found in the gaming machine 10 are described below, it should be understood that numerous other elements may exist and may be used in any number of combinations to create various forms of a gaming machine 10.

The value input device 18 may be provided in many forms, individually or in combination, and is preferably located on the front of the housing 12. The value input device 18 receives currency and/or credits that are inserted by a player. The value input device 18 may include a coin acceptor 20 for receiving coin currency (see FIG. 1). Alternatively, or in addition, the value input device 18 may include a bill acceptor 22 for receiving paper currency. Furthermore, the value input device 18 may include a ticket reader, or barcode scanner, for reading information stored on a credit ticket, a card, or other tangible portable credit storage device. The credit ticket or card may also authorize access to a central account, which can transfer money to the gaming machine 10.

The player input device 24 comprises a plurality of push buttons 26 on a button panel for operating the gaming machine 10. In addition, or alternatively, the player input device 24 may comprise a touch screen 28 mounted by adhesive, tape, or the like over the primary display 14 and/or secondary display 16. The touch screen 28 contains soft touch keys 30 denoted by graphics on the underlying primary display 14 and used to operate the gaming machine 10. The touch screen 28 provides players with an alternative method of input. A player enables a desired function either by touching the touch screen 28 at an appropriate touch key 30 or by pressing an appropriate push button 26 on the button panel. The touch keys 30 may be used to implement the same functions as push buttons 26. Alternatively, the push buttons 26 may provide inputs for one aspect of the operating the game, while the touch keys 30 may allow for input needed for another aspect of the game.

The various components of the gaming machine 10 may be connected directly to, or contained within, the housing 12, as seen in FIG. 1, or may be located outboard of the housing 12 and connected to the housing 12 via a variety of different wired or wireless connection methods. Thus, the gaming machine 10 comprises these components whether housed in the housing 12, or outboard of the housing 12 and connected remotely.

The operation of the basic wagering game is displayed to the player on the primary display 14. The primary display 14 can also display the bonus game associated with the basic wagering game. Preferably, as seen in FIG. 1, the primary display 14 includes a plurality of mechanical reels 60 to display the outcome of the wagering game. More specifically, the mechanical reels 60 each bear a plurality of symbols 62 positioned around the periphery of the reels 60. Winning combinations of symbols 62 landing on at least one payline 32 are awarded in accordance with a paytable. Alternatively, the primary display 14 may take the form of a cathode ray tube (CRT), a high resolution LCD, a plasma display, an LED, or any other type of display suitable for use in the gaming machine 10. In the illustrated embodiment, the gaming machine 10 is an “upright” version in which the primary display 14 is oriented vertically relative to the player. Alternatively, the gaming machine may be a “slant-top” version in which the primary display 14 is slanted at about a thirty-degree angle toward the player of the gaming machine 10.

A player begins play of the basic wagering game by making a wager via the value input device 18 of the gaming machine 10. A player can select play by using the player input device 24, via the buttons 26 or the touch screen keys 30. The basic game consists of a plurality of symbols arranged in an array, and includes at least one payline 32 that indicates one or more outcomes of the basic game. Such outcomes are randomly selected in response to the wagering input by the player. At least one of the plurality of randomly-selected outcomes may be a start-bonus outcome, which can include any variations of symbols or symbol combinations triggering a bonus game.

In some embodiments, the gaming machine 10 may also include a player information reader 52 that allows for identification of a player by reading a card with information indicating his or her true identity. The player information reader 52 is shown in FIG. 1 as a card reader, but may take on many forms including a ticket reader, bar code scanner, RFID transceiver or computer readable storage medium interface. Currently, identification is generally used by casinos for rewarding certain players with complimentary services or special offers. For example, a player may be enrolled in the gaming establishment's loyalty club and may be awarded certain complimentary services as that player collects points in his or her player-tracking account. The player inserts his or her card into the player information reader 52, which allows the casino's computers to register that player's wagering at the gaming machine 10. The gaming machine 10 may use the secondary display 16 or other dedicated player-tracking display for providing the player with information about his or her account or other player-specific information. Also, in some embodiments, the information reader 52 may be used to restore game assets that the player achieved and saved during a previous game session.

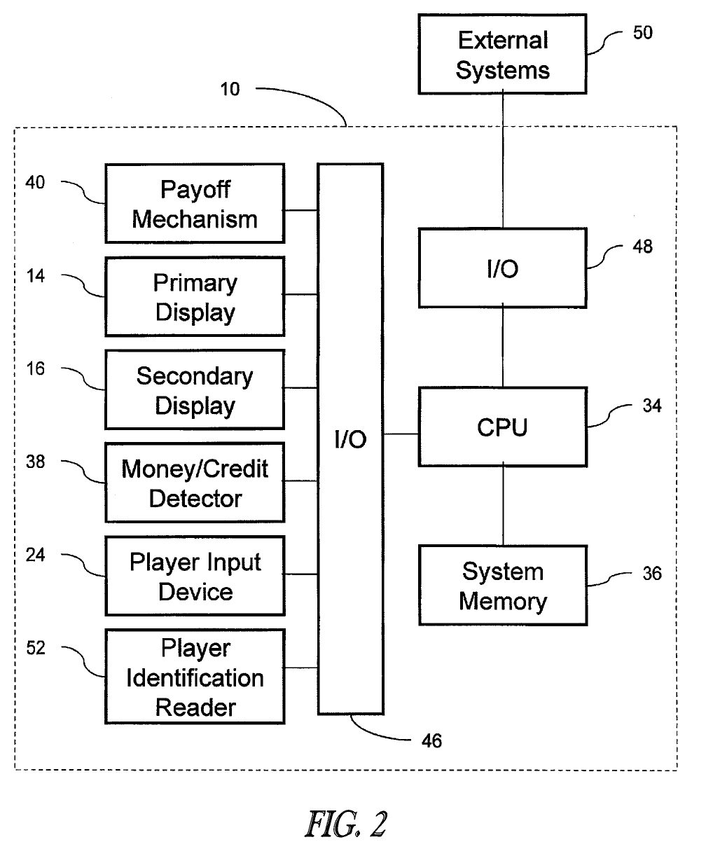

Turning now to FIG. 2, the various components of the gaming machine 10 are controlled by a central processing unit (CPU) 34, also referred to herein as a controller or processor (such as a microcontroller or microprocessor). To provide gaming functions, the controller 34 executes one or more game programs stored in a computer readable storage medium, in the form of memory 36. The controller 34 performs the random selection (using a random number generator (RNG)) of an outcome from the plurality of possible outcomes of the wagering game. Alternatively, the random event may be determined at a remote controller. The remote controller may use either an RNG or pooling scheme for its central determination of a game outcome. It should be appreciated that the controller 34 may include one or more microprocessors, including but not limited to a master processor, a slave processor, and a secondary or parallel processor.

The controller 34 is also coupled to the system memory 36 and a money/credit detector 38. The system memory 36 may comprise a volatile memory (e.g., a random-access memory (RAM)) and a non-volatile memory (e.g., an EEPROM). The system memory 36 may include multiple RAM and multiple program memories. The money/credit detector 38 signals the processor that money and/or credits have been input via the value input device 18. Preferably, these components are located within the housing 12 of the gaming machine 10. However, as explained above, these components may be located outboard of the housing 12 and connected to the remainder of the components of the gaming machine 10 via a variety of different wired or wireless connection methods.

As seen in FIG. 2, the controller 34 is also connected to, and controls, the primary display 14, the player input device 24, and a payoff mechanism 40. The payoff mechanism 40 is operable in response to instructions from the controller 34 to award a payoff to the player in response to certain winning outcomes that might occur in the basic game or the bonus game(s). The payoff may be provided in the form of points, bills, tickets, coupons, cards, etc. For example, in FIG. 1, the payoff mechanism 40 includes both a ticket printer 42 and a coin outlet 44. However, any of a variety of payoff mechanisms 40 well known in the art may be implemented, including cards, coins, tickets, smartcards, cash, etc. The payoff amounts distributed by the payoff mechanism 40 are determined by one or more pay tables stored in the system memory 36.

Communications between the controller 34 and both the peripheral components of the gaming machine 10 and external systems 50 occur through input/output (I/O) circuits 46, 48. More specifically, the controller 34 controls and receives inputs from the peripheral components of the gaming machine 10 through the input/output circuits 46. Further, the controller 34 communicates with the external systems 50 via the I/O circuits 48 and a communication path (e.g., serial, parallel, IR, RC, 10bT, etc.). The external systems 50 may include a gaming network, other gaming machines, a gaming server, communications hardware, or a variety of other interfaced systems or components. Although the I/O circuits 46, 48 may be shown as a single block, it should be appreciated that each of the I/O circuits 46, 48 may include a number of different types of I/O circuits.

Controller 34, as used herein, comprises any combination of hardware, software, and/or firmware that may be disposed or resident inside and/or outside of the gaming machine 10 that may communicate with and/or control the transfer of data between the gaming machine 10 and a bus, another computer, processor, or device and/or a service and/or a network. The controller 34 may comprise one or more controllers or processors. In FIG. 2, the controller 34 in the gaming machine 10 is depicted as comprising a CPU, but the controller 34 may alternatively comprise a CPU in combination with other components, such as the I/O circuits 46, 48 and the system memory 36.

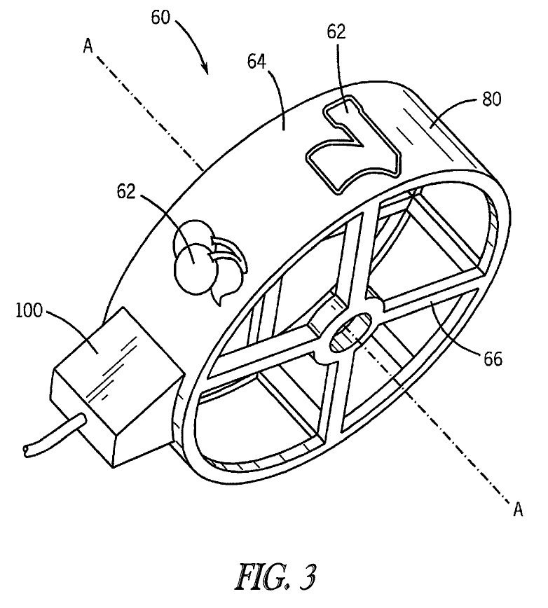

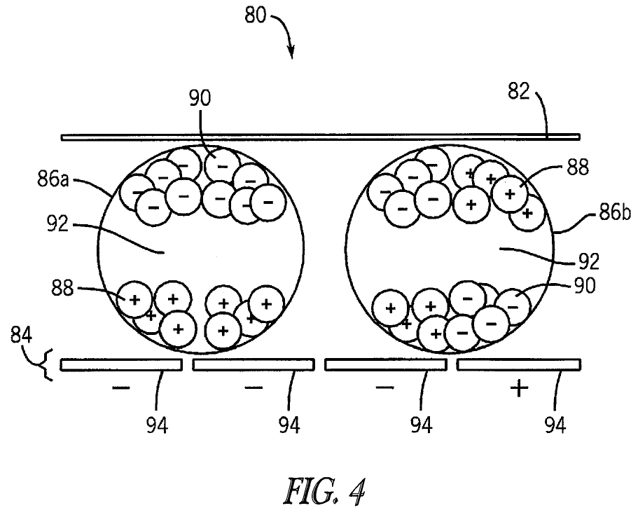

Turning now to FIG. 3, a perspective view of one of the mechanical reels 60 of the primary display 14 of the gaming machine 10 is depicted. The reel 60 includes a reel strip 64 circumferentially mounted around a cage or drum 66. The cage 66 forms a cylindrical support mechanism onto which the reel strip 64 is mounted. The cage 66 is rotatable about a central axis AA. Preferably all of the reels 60 of the gaming machine 10 are mounted to be rotatable about axes parallel to axis AA. The cage 66 may be constructed of any suitable material to create a rigid or semi-rigid support for the reel strip 64, but preferably the cage 66 is fabricated of plastic. The reel strip 64 bears a plurality of symbols 62 about the periphery of the reel 60. The symbols 62 may include any variety of symbols including blanks which form combinations appearing on a payline 32 after each play or spin of the slot game. Certain combinations of symbols 62 are defined as winning combinations for which awards are paid to the player in accordance with a paytable. According to the present invention, the symbols 62 on the reel strip 64 are modifiable due to the construction of the reel strip 64. The reel strip 64 comprises a cylindrical band of electrophoretic film 80. Electrophoretic film 80 (or paper) may also be referred to as e-paper, digital paper, electronic ink, or digital ink and is commercially available from such companies as E Ink Corporation of Cambridge, Mass. and Magink Display Technologies, Inc. of San Bruno, Calif. The electrophoretic film 80 is in communication with a data source 100 which controls the appearance and modification of the symbols 64 on the film 80. Specifically, the data source modifies the charges at the charge points 94 (see FIG. 4) to change the appearance of the video images, in this case symbols 62, on the reel strip 64 formed by the film 80. The data source 100 may be mounted either on the outside of the reel 60 as seen in FIG. 3, or may alternatively be mounted on the inside or on either the left or right side of the reel 60 such that it is proximate the reel strip 64.

A cross-section of the electrophoretic film 80 is depicted in FIG. 4. The film 80 comprises a top transparent electrode 82, a bottom electrode 84, and a plurality of microcapsules 86 positioned between the two electrodes 82,84. The top electrode 82 is constructed of a transparent or translucent material so as to permit light to reflect off of the microcapsules 86 making them visible. Thus, the top electrode 82 comprises the viewable side of the film 80. Each of the microcapsules 86 comprises a plurality of positively charged particles 88 and negatively charged particles 90 suspended in a transparent or clear fluid medium 92. Preferably the positively charged particles 88 are a first color while the negatively charged particles 90 are a second color. In one embodiment, the positively charged particles 88 are white, while the negatively charged particles 90 are black. The particles 88,90 are free to move about the microcapsule 86 by translating through the fluid 92 contained therein.

The bottom electrode 84 comprises a plurality of charge points 94. Each microcapsule is associated with one or more charge points 94 as seen in FIG. 4. In one embodiment, each microcapsule 86 is associated with, and controlled by, two charge points 94. The charge points 94 may carry either a positive charge or a negative charge of varying strength, and transmit such charge to the associated microcapsule 86. For example, looking at the first microcapsule 86a in FIG. 4, a negative charge is applied by both charge points 94. This causes the negatively charged particles 90 to be repelled by the like charged charge points 94 while the positively charged particles 88 are attracted by the oppositely charged charge points 94. This causes separation of the colored particles 88, 90, causing the negatively charged particles 90 to move to the top or front side of the microcapsule 86a, while the positively charged particles 88 move to the bottom or back side of the microcapsule 86a. With the negatively charged particles 90 accumulating on the front side of the microcapsule 86a nearest the top transparent electrode 82, the point on the top electrode adjacent to the microcapsule 86a appears the color of the negatively charged particles 90, which in this embodiment is black. However, it should be understood that the particles 88,90 may be colored any combination of two colors, providing that there is a visual contrast between the colors. Moreover, more than two colors or shades may be utilized within a single microcapsule 86 to provide a variety of visual and shading effects. For example, in one embodiment, clusters of red, green, and blue microcapsules 86 form pixels which may be colored any color of visible light by varying the intensities of the three primary colors of the microcapsules 86. Other embodiments using two or more colors are possible based upon various configurations of the particles 88,90 within the microcapsules 86, and the arrangement of the microcapsules 86 themselves within the film 80.

A second example is shown by a second microcapsule 86b in FIG. 4. In this instance, the charge points 94 are charged differently, with one point 94 being charged negatively while the other point 94 is charged with a positive charge. Such a configuration causes a mixture of negatively charged particles 90 and positively charged particles 88 in the microcapsule 86b to accumulate at the back of the microcapsule 86a nearest the charge points 94. Similarly, a mixture of negatively and positively charged particles 90,88 accumulate near the front of the microcapsule 86b nearest the top transparent electrode 82. This mixture causes the microcapsule 86b to appear a mixture of the two colors of the particles 88, 90, which in this embodiment appears a gray color as a mixture of black and white particles 88,90. It should be understood that varying the strength of negative charge point 94 relative to the positive charge point 94 affects the balance of negatively charged particles 90 and positively charged particles 88 accumulating on the opposite sides of the microcapsule 86b. In this way, controlling the charges and strength of charge on the charge points 94 adjusts the mixture of the two colors of charged particles 88,90, permitting the microcapsule 86b to be adjusted across an entire range of shades or colors comprised by mixing various amounts of the two colors of the particles 88,90. In the black and white example shown, the adjustable mixing permits gray-scale shading from white to black and a variety of shades of gray in between.

The electrophoretic film 80 may be placed in proximity to a data source 100 which controls the nature and strength of the charges points 94. Preferably, the film 80 is laminated to a layer of circuitry which serves as the data source 100 for the charge points 94, although a variety of data sources 100 may be used to transfer data and information to the film 80 containing the video images to be displayed. The circuitry forms a pattern of pixels at the charge points 94 that can be controlled by a display driver in communication with the circuitry. Furthermore, the microcapsules 86 may be suspended in a liquid medium which permits them to be printed onto virtually any surface using screen printing and other printing techniques. This permits the microcapsules 86 to be applied or “printed” on virtually any medium including glass, plastic, fabric, and even paper. One embodiment of an electrophoretic display is formed by printing the microcapsules onto a layer of plastic or other substrate and then laminating the substrate over a layer of circuitry. Because the substrate is configured to be relatively thin, the charge points 94 remain in communication with the microcapsules 86 for purposes of activating color changes in the microcapsules 86 as described.

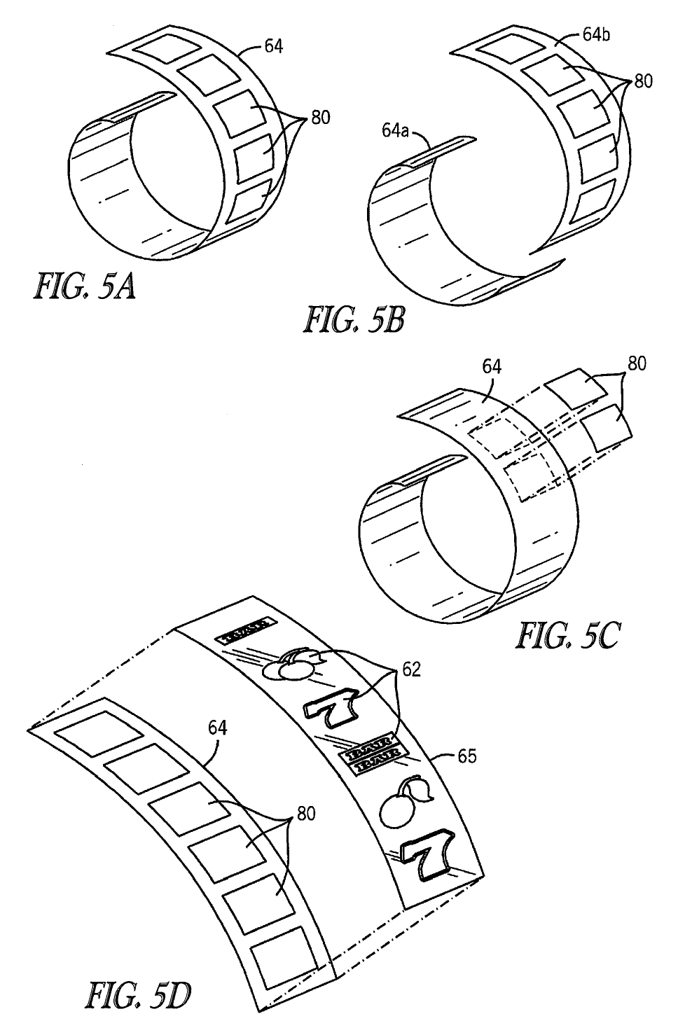

Alternate embodiments of reels 60 using electrophoretic films 80 are depicted in FIGS. 5a-d. In FIG. 5a, a reel strip 64 is shown. Unlike the reel strip 64 in FIG. 3, the reel strip 64 in FIG. 5a is not entirely made of electrophoretic film 80, but rather includes a plurality of electrophoretic film portions 80. In this way, the reel strip 64 may include static display portions as well as the dynamic displays provided by the electrophoretic films 80. The films 80 may be positioned so as to correspond to each symbol position on the reel 60, or only selected symbol positions. In FIG. 5b, an alternative embodiment is shown whereby two or more reel strip portions 64a,b are utilized to form the entire reel strip 64. Each portion 64a,b includes one or more electrophoretic film portions 80 in one or more symbol positions. Yet another alternative, depicted in FIG. 5c, is a single reel strip 64 upon which one or more electrophoretic films 80 are applied in selected positions to form dynamic displays. In FIG. 5d a fourth alternative is depicted. The reel strip 64 in FIG. 5d comprises a plurality of electrophoretic films 80 as in FIGS. 5a and 5b. However, in addition to the electrophoretic displays 80, the entire reel strip 64 in FIG. 5d may be overlaid with a static reel strip 65. The static reel strip 65 includes a plurality of symbols 62. Preferably at least a portion of the static reel strip 65 is translucent or transparent so as to permit the dynamic displays of the underlying electrophoretic films 80 to be transmitted through the static reel strip 65. This configuration allows the reel 60 to display dynamic graphics on the electrophoretic films 80 in combination with the static symbols 62 on the static reel strip 64 which overly the films 80. In each of these configurations, the electrophoretic films 80 receive display data from one or more communication sources 100, as shown in FIG. 3.

One of the benefits of the electrophoretic film 80 is its flexibility, thereby permitting the film 80 to be used to create a dynamic electronic display on a variety of curved and non-rigid surfaces. For example, as described with relation to FIG. 3, the electrophoretic film 80 may be shaped in cylindrical band to form a reel strip 64 on a mechanical reel 60. Given the rotating nature of the reel 60, a variety of techniques may be used to impart changes on the graphics of the electrophoretic reel strip 64. For example, in one embodiment, data in the form of changes in the charges of the charge points 94 on the film 80 forming the reel strip 64 is transferred to the reels 60 with brush contacts positioned in the gaming machine 10 in communication with the reel strip 64. Preferably the brush contacts are in communication with the data source, and are positioned behind the reel strip 64 within the space formed by the cage 66 of the reel 60. In another embodiment, the data is transferred to the reels by magnetic induction through one or more magnets placed in communication the reels 60. In yet another embodiment, a component facing the reel “paints” the image onto the strip as it rotates by using discrete spatial differences in charge points 94 generated to impart a new image to the electrophoretic film 80 forming the reel strip 64. Thus, the data source 100 may transfer information as to the video image to be displayed by film 80 via any number of methods, both through wired or wireless (or “contactless”) communications, so as to adjust and configure the charge points 94 to properly display the desired image.

In an alternative embodiment, the reel strips 64 of the gaming machine 10, rather than comprising electrophoretic film 80, comprises flexible LCD displays wrapped around and mounted to the reel cage 66. The flexible LCD displays are arranged circumferentially about the cage 66 to produce a dynamic display on the reel 60. The flexible LCD displays are manufactured using plastic substrates rather than rigid glass substrates, thereby allowing the LCD display to bend and be flexible such that it may be mounted about the cage. The flexible LCD displays include many of the properties of traditional LCD displays such as ability to display many colors. Flexible LCD displays are commercially available from Samsung Electronics Co., Ltd. of Seoul, South Korea. The flexible LCD displays mounted on the cage 66 to form the reel 60 may receive image and display data from the data source 100. Such information, as with the electrophoretic film 80, may be communicated through wired transmissions, contactless or wireless transmissions, or rotating brush contacts. Moreover, the flexible LCD display may be used in conjunction with traditional reel strips or electrophoretic film 80 to create a multi-layered reel 60.

One example of contactless communications which may be used to configure communications between the data source 100 and the film forming the reel strip 64, such as that depicted in FIG. 3, utilizing a data source 100 that includes a low power RF transmitter and a corresponding antennae connected to the film 80 on the reel strip 64. In one embodiment, the antennae is arranged circularly within the inside of the reel 60 and placed in communication with the film 80 comprising the reel strip 64. The circular orientation of the antenna permits it to receive transmissions from the RF transmitter regardless of the position of the reel 60, or even while the reel 60 is spinning. The antennae receives data communication in radio frequency form from the data source 100, which is an RF transmitter mounted or suspended in close proximity to the inside of the reel 60 drum. A weak near field RF field is used to power and communicate between these electronics providing contactless communications. One such system utilizing and RF transmitter and antennae is manufactured by Fujitsu Laboratories, Ltd. of Tokyo, Japan. This contactless communication from the data source 100 to the film 80 requires very low power and allows for high reliability data transfer and long mechanism life, as compared to sliding or touching contacts where maintenance remains a continuous issue. Other forms of contactless or wireless data communications between the data source 100 and the film 80 on the reel strip 64 may also be utilized.

In addition to the reel strips 64, the electrophoretic film 80 may be applied to various other components or portions of the gaming machine 10 for purposes of producing a variable electronic display. For example, the film 80 may be mounted on a top box of the machine 10, or on the secondary display 16 of the machine 10 for purposes of providing gameplay information, casino information, or signage on the gaming machine 10. The film 80 may also be mounted on various portions of the housing 12, including the sides, front, and top of the housing 12, to provide various visual information to players and casino personnel. In another embodiment, the film 80 may be applied to various peripherals on the gaming machine 10, such as the buttons 26 of the player input device 24. Specifically, the buttons 26 of the player input device 24, which may be mechanical, electro-mechanical, or soft buttons, may comprise one or more labels, indicators, designs, or indicia formed by one or more piece of electrophoretic film 80. The film 80 on the buttons 26 may in turn be in communication with the processor 34 such that the labels or indicia on the buttons 26 may be dynamically configured. In this way, for example, the processor 34 may download a different game to be played on the machine 10, which may include a different set of indicia on the buttons 26. The film 80 on the buttons 26 may then be modified by the processor 34 to display the new indicia for the new game on the gaming machine 10. Thus, the film 80 on the buttons 26 serves as a dynamic button display or label, and may be used for altering button displays, animations, indicia, labels, or other purposes. The payoff mechanism 40, player information reader 52, and other peripherals on the machine 10 may also be configured to display information with a modifiable display formed of electrophoretic film 80. Moreover, the film 80 may be used in conjunction with one or more standard video displays, such as a CRT or LCD display. The film 80 may also be utilized in conjunction with a touch screen 28 and soft touch keys 30 to form an alternate player input device 24 on the gaming machine 10.

Moreover, the electrophoretic film 80 may be applied to a variety of removable or interfaceable media utilized in conjunction with the gaming machine 10 to create a variable display thereon. For example, a player tracking card used in conjunction with the player information reader 52 may be outfitted with a display formed from electrophoretic film 80. The film 80 on the tracking card may be modified by the player information reader 52 when the card is inserted or removed from the reader 52. The film 80 on the tracking card may be utilized to provide various gaming and casino information to the player, for example, gaming and statistical information tracked by the tracking card. In this way, the player may receive a visual display of the status of current information tracked on the card each time the card is inserted and removed from the reader 52. In another embodiment, the ticket printer 42 may print tickets bearing a display formed by the electrophoretic film 80. Thus each time a player cashes out credit from the machine 10 via the ticket printer 42, he or she may receive a ticket bearing a variable display formed from the film 80. The film 80 on the ticket may be used to display gaming and casino information to the player, such as credit balances on the ticket, for example. The types of information visually displayed by the film may vary and is virtually limitless.

The electrophoretic film 80 may be used to dynamically alter the reels 60, displays 14,16, or other signage on the housing 12 of the gaming machine 10 by interfacing with the external systems 50, such as a gaming network, other gaming machines, a gaming server, communications hardware, etc. The external systems 50 may include a download server that communicates with the processor 34 of the gaming machine 10 to download a variety of images, graphics, and display elements to be displayed on the electrophoretic film 80. Specifically, the download server may transfer image data to gaming machine 10, which may transfer the image data to the data source 100 under control of the processor 34. The data source 100 may then utilize the downloaded image data to rewrite or alter the image displayed on the film 80 in communication with the data source 100. This allows, for example, the symbols 62 on the reel 60 to be altered, modified, or exchanged from one set of symbols 62 to another set of symbols 62. Alternatively, the symbols 62 may be modified slightly for visual effect, or even animated. The image data from the external systems 50 may also be transferred directly to the film 80, such as electrophoretic film 80 forming a signage display on the housing 12 of the gaming machine 10. In such a direct configuration, the data source 100 is not required, and the image data is communicated to the film 80 by the processor 34 of the machine 10. Any number of downloadable scenarios exists for downloading image data from external systems 50 to various electrophoretic films 80 on the gaming machine 10. Furthermore, it should be understood that some or all of the image data may be stored locally on the machine in system memory 36 or other storage devices.

The gaming machine 10 of the present invention offers a number of benefits and advantages over traditional gaming machines. Firstly, configuring reel strips 64 out of electrophoretic film 80 permits the use of mechanical reels 60 which have dynamically alterable image displays on them. Such a configuration allows the symbols 62 on the reel strips 64 to be altered, animated, or changed without the need to physically alter the machine 10. This provides a large benefit in reducing the amount of time the gaming machine 10 is unavailable for play and thereby increases profit on the machine 10. Furthermore, the use of the electrophoretic film 80 on other components of the gaming machine 10, such as a secondary display 16, signage on the housing 12, or input buttons 26, improves the esthetic value of these components and permits them to be altered or changed without physically altering the machine 10. This allows the operator of such a gaming machine 10 to download a new theme and game to the gaming machine 10 from external systems 50, which would include altering the buttons 26, signage on the housing 12 and displays 14,16 to display images associated with the new downloaded game or theme. This provides a significant benefit by allowing dynamic electronic modification of the displays of the gaming machine 10. Moreover, the electrophoretic film 80 provides the added benefits including providing superior viewing characteristics of paper such as high contrast, wide viewing angle and bright background; versatility in that the electrophoretic film may comprise many surfaces including plastic, metal and paper; and cost savings through low power dissipation relative to traditional displays.

Each of these embodiments and obvious variations thereof is contemplated as falling within the spirit and scope of the claimed invention, which is set forth in the following claims.

What is claimed is:

1. A gaming machine comprising:
a value input device for receiving a wager;
a housing attached to the value input device;
a display attached to the housing, the display for displaying a plurality of symbols, the symbols indicating a randomly-selected outcome selected from a plurality of possible outcomes, the plurality of outcomes including at least one winning outcome; and
a controller attached to the housing and operative to alter appearance of electrophoretic film forming an alterable display, wherein a first part of the electrophoretic film is attached to at least one of a player tracking card or a credit ticket.

2. The gaming machine of claim 1, wherein a second part of the electrophoretic film is positioned on at least one button supported by the housing.

3. The gaming machine of claim 1, wherein a second part of the electrophoretic film is positioned on the housing to display signage associated with a theme of the gaming machine.

4. The gaming machine of claim 1, wherein the controller is operative to download a first image and a second image from one or more external systems, wherein the controller is operative to configure the electrophoretic film to selectively display either the first image or the second image.

5. The gaming machine of claim 1, comprising:
at least one rotatable reel comprising a reel strip arranged about the periphery of a cage, the reel strip comprising a second portion of the electrophoretic film for displaying a plurality of symbols.

6. An apparatus, comprising:
a gaming machine player tracking card; and
a display comprising an electrophoretic film attached to the card, wherein the electrophoretic film is alterable by a gaming machine player information reader upon at least one of inserting or removing the card from the reader.

7. The apparatus of claim 6, wherein the electrophoretic film is alterable to display gaming information.

8. The apparatus of claim 6, wherein the electrophoretic film is alterable to display wagering game statistical information.

9. The apparatus of claim 6, wherein the electrophoretic film is alterable to display casino information.

10. The apparatus of claim 6, wherein the electrophoretic film is alterable to display wagering game indicia.

11. The apparatus of claim 6, wherein the electrophoretic film is alterable to display status of information tracked by the tracking card upon at least one of the inserting or the removing.

12. An apparatus, comprising:
a gaming machine credit ticket; and
a display comprising an electrophoretic film attached to the ticket, wherein the electrophoretic film is alterable by a gaming machine ticket printer.

13. The apparatus of claim 12, wherein the electrophoretic film is alterable to display gaming information.

14. The apparatus of claim 12, wherein the electrophoretic film is alterable to display casino information.

15. The apparatus of claim 12, wherein the electrophoretic film is alterable to display a player credit balance.

16. The apparatus of claim 12, wherein the electrophoretic film is alterable to display wagering game indicia.
